(19) United States
(12) Patent Application Publication
(10) Pub. No.: US 2008/0265899 A1
(43) Pub. Date: Oct. 30, 2008

(54) Method and System for Visual Circuit Verification

(76) Inventor: Paul Spivak, Mayfield Heights, OH (US)

Correspondence Address: PATENT, COPYRIGHT & TRADEMARK LAW GROUP, 4199 Kinross Lakes Parkway, Suite 275, RICHFIELD, OH, 44286, US

(21) Appl. No.: 12/110,011

(22) Filed: Apr. 25, 2008

Related U.S. Application Data
(60) Provisional application No. 60/914,145, filed on Apr. 26, 2007.

(51) Int. Cl. F02M 65/00; F02P 17/00

(52) U.S. Cl. 324/378

(57) ABSTRACT

A visual indicator system comprises a fuel injector pulse width signal generator in communication with an engine fuel injector by means of a circuit wire. A visual indicator is in circuit communication with the circuit wire and configured to light up in a first stage to indicate a good electrical connection of the fuel injector to the fuel injector pulse width signal generator to the engine fuel injector when the fuel injector signal generator, the engine fuel injector and the circuit wire are energized by a vehicle ignition system. The visual indicator is further configured to light up a second stage to indicate a good pulse width signal generator operation when an automobile engine is running through operation of the fuel injector signal generator, the engine fuel injector and the circuit wire.

### RELATED APPLICATIONS

The present application is a Continuation-in-Part of U.S. Ser. No. 60/914,145 and it claims a priority to the provisional's Apr. 26, 2007 filing date. The present application incorporates the subject matter disclosed in ('145) as if it is fully rewritten herein.

### BACKGROUND OF THE INVENTION

### 1. Field of the Invention

The present invention relates to systems for the controlled combusting of fuels, and, more particularly, to internal combustion engine system fuel injector systems configured to operate on multiple types of fuel.

### SUMMARY OF THE INVENTION

In an internal combustion engine fuel is ignited and burned in a combustion chamber, wherein an exothermic reaction of the fuel with an oxidizer creates gases of high temperature and pressure. The pressure of the expanding gases directly act upon and cause a corresponding movement of pistons, rotors, or other elements, which are operationally engaged by a one or transmission systems to translate the element movement into working or motive forces.

The most common and important application of the internal combustion engine is the automobile, and due to its high energy density, relative availability and fully developed supply infrastructure, the most common fuels used in automobile engines in the United States of America and throughout the world are petroleum-based fuels, namely, gasoline and diesel fuel blends; however, a reliance upon petroleum-based fuels generates carbon dioxide, and the operation of millions of automobiles world-wide results in the release of a significant total amount of carbon dioxide into the atmosphere, wherein the scale of the amount generated is believed to contribute to global warming.

The petroleum acquisition and transportation operations associated with producing automotive fuels for the world also result in significant social and environmental impacts. For example, petroleum drilling and transportation discharges and by-products frequently cause significant harm to natural resources. The limited and unequal geographic distribution of significant sources of petroleum within a relatively small number of nations renders large consuming nations (such as the United States) net-importers dependent upon nations and sources outside of domestic political control which has exasperated or directly resulted in international conflicts, social unrest and even warfare in many regions of the world.

One solution is to reduce the conventional automobile's reliance on petroleum-based fuel by substituting one or more economically and socially feasible alternative fuels, energy sources or motive energy systems. Many types of alternative fuels are available or have been proposed for use with internal combustion engines, including gasoline-type bio fuels such as E85 (a blend of 15% gasoline and 85% ethanol) and P-series fuels, and diesel-type biofuels such as hempseed oil fuel or other vegetable oils. Alternative power systems (illustrative but not exhaustive examples include hydrogen combustion or fuel-cell systems, compressed or liquefied natural gas or propane gas systems, and electric motor systems) may also replace an internal combustion engine or be used in combination therewith in a “hybrid” system.

However, the costs of adopting alternative fuels or power systems on a large scale are significant. In particular, the investment required to build an infrastructure necessary to support any one of the alternative fuels or power systems on a scale that will enable a migration away from the internal combustion gasoline or diesel engine is prohibitively large. Accordingly, at present, alternative fuel or power system automobiles make up only a very small fraction of the world's automobiles. A more cost-effective approach is to modify existing conventional internal combustion automobiles and support infrastructures to replace petroleum-based fuels with one or more alternative fuels.

Problems arise in modifying existing conventional automobiles in that internal combustion gasoline or diesel engines are designed to operate on fuel specifications that severely limit the possibilities of using alternative fuels since known alternative fuel blends diverge greatly from conventional petroleum-based fuel specifications. For example 25% more E85 is required to generate the motive power of gasoline, and thus gasoline engine fuel injectors must be controlled to allow about 25% more E85 into engine combustion chambers to generate the same engine performance.

One way to enable or optimize alternative fuel use is to modify conventional automobile fuel injector pulse widths. In one example, a pulse width amplifier is introduced into a conventional automobile engine system between the original equipment manufacturers' (OEM) fuel injection controllers and the fuel injectors, wherein E85 fuel use is enabled by amplifying fuel injector pulse width signals to keep the fuel injectors open 25% longer.

The foregoing solution has its disadvantages: improper installation of pulse width amplifiers may result in faulty electrical connections. Modern engine control systems are tightly integrated and they rely upon observation of a number of performance parameters in order to ensure proper engine performance. In particular, governmental vehicle emission standards require engine Onboard Diagnostic Systems (OBDs) to monitor a number of specific performance parameters for engine malfunctions that result in unacceptable increases in pollutant emissions. Faulty electrical connections may cause one or more of the fuel injectors to fail to operate or they may otherwise evidence faulty behavior, even though the “faulty” injector would otherwise work properly. This may result in the OBD mis-reporting or misdiagnosing a faulty fuel injector, which may result in inefficient, costly and needless automobile servicing.

A long need is thus felt for a method or a system that addresses the problems discussed above.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 illustrates a portion of a conventional PRIOR ART automobile fuel injector system; and,

FIG. 2 illustrates portions of an automobile fuel injector system in accordance with a preferred embodiment of the present invention;

wherein the drawings are not necessarily to scale. The drawings are merely schematic representations not intended to portray specific parameters of the invention. The drawings are intended to depict only typical embodiments of the invention, and therefore they should not be considered as limiting the scope.

### DESCRIPTION OF THE PREFERRED EMBODIMENTS

### 1. Detailed Description of the Figures

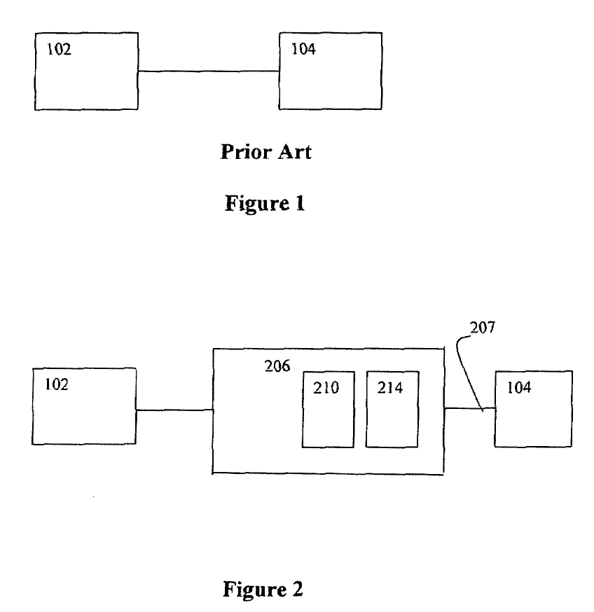

Referring now to FIG. 1, a gasoline internal combustion engine control unit (ECU) 102 is shown in communication with and configured to control a conventional automobile fuel injector component 104. The fuel injector component 104 comprises a plurality of electronically controlled valves with at least one valve provided for each engine cylinder. The valves are each supplied with pressurized fuel by a fuel pump (not shown). The valves are configured to open and close many times per second, and the amount of fuel supplied to the engine is determined by the amount of time the fuel injector stays open. The length of time is called the “pulse width” and it is controlled by ECU 102 pulse width signals.

The pulse width signals control the amount and rate of fuel injected into each engine combustion chamber, thereby controlling the combustion chamber air-fuel ratio (AFR). The AFR is the mass ratio of air to fuel present during combustion. When all the fuel is combined with all the free oxygen within the combustion chamber, the mixture is chemically balanced and this AFR is called the stoichiometric mixture, which is ignited by the automobile ignition system in a timing coordination with cylinder head positioning and anticipated time of ignition and combustion. Each fuel has a preferred AFR or range of AFRs which will achieve optimal fuel combustion when ignited, and which is dependent in part on the amount of hydrogen and carbon found in a given amount of fuel. AFRs below preferred value(s) result in a rich mixture, wherein unburned fuel is left over after combustion and exhausted, wasting fuel and creating pollution. Alternatively, AFRs above preferred value(s) result in a lean mixture having excess oxygen, which tends to produce more nitrogen-oxide pollutants and can cause poor performance and even engine damage.

Problems arise if the fuel injector component 104 is used with alternative fuels. For example, E85 fuel combustion generates lower energy as measured in British Thermal Units (BTUs) than gasoline fuel blends, and thus higher pulse widths are required to generate comparable engine performances under similar operating parameters. FIG. 2 provides an alternative fuel injector control system according to the present invention, wherein a Pulse Modifier 206 is provided interposed between the ECU 102 and the fuel injector component 104. The Pulse Modifier 206 modifies the ECU 102 pulse width signals to enable the fuel injectors 104 to efficiently operate on one or more alternative fuels, e.g., widening the pulse widths for E85, or narrowing the pulse widths for alternative fuels having higher BTU performance characteristics relative to gasoline or diesel fuel blends. The Pulse Modifier 206 may be programmed or otherwise configured by a manufacturer, an after-market retailer or installer, or by some other service provider. It may also be subsequently re-programmed as required to provide optimal fuel injector settings for one or more specified alternative fuels.

In an example illustrated in FIG. 2, the Pulse Modifier 206 is inserted between the ECU 102 and the fuel injectors 104. The Pulse Modifier 206 is in direct circuit communication 207 with each of the fuel injectors 104 to thereby provide each fuel injector with a modified pulse width signal; however, improper installation of the Pulse Modifier 206 may result in a faulty electrical connection 207, thus causing the fuel injector 104 to fail to operate or to evidence faulty behavior. This may occur through failure by a customer or an installer to properly read or follow installation instructions or to otherwise fail to form a good electrical connection 207 in initial unit installation. The connection 207 may also fail subsequent to proper installation, s.a., e.g., vibrating loose through engine operation, or suffering damage while adjacent parts are being serviced.

The Pulse Modifier 206 according to the present invention addresses some of these problems by incorporating a visual status indicator 210 for each wired connection 207. The visual status indicator 210 may be incorporated on a visible surface of the Pulse Modifier 206 or it may be directly incorporated in each connection wire 207 leading to each fuel injector 104. In some embodiments, the visual status indicator 210 comprises one or more light emitting diodes (LEDs), though other visual indicators may be practiced with the present invention. The visual status indicator 210 is thus configured to “light up” when the Pulse Modifier 206 is properly installed, operating correctly and/or communicating correctly with the fuel injector 104.

In some embodiments, each visual status indicator 210 lights up after an engine is started and they each remain lit to indicate that the Pulse Modifier 210 is working and communicating properly with the fuel injector 104. The visual status indicator 210 quickly and efficiently provides visual diagnostic information to an owner/operator/service technician, greatly reducing diagnostic times and costs. For example, if the Pulse Modifier 206 is installed and the engine is not operating properly, each of the visual status indicators 210 may be quickly checked visually; if one is not lit, then the associated fuel injector 104 connection 207 is inspected. If the connection 207 is physically intact, yet the visual status indicator 207 remains unlit, then a fuel injector 104 fault is quickly diagnosed.

In various embodiments, the visual status indicator has multiple visual modes and/or components 210/214. In one example, when the Pulse Modifier 206 is energized, but the engine is not yet started, such as by turning an ignition key into a “run” position, but prior to a “start” position, then one or more first stage red LED status indicators 210 light up to indicate that the connection 207 is connected properly. Then after the engine is started and the Pulse Modifier 206 is operating and communicating properly with the fuel injector 104, one or more second stage green LED status indicators 214 light up—the visual status thus changing from red to green. The visual status indicators 210/214 may indicate either or both that the Pulse Modifier 206 is connected and/or working properly, resulting in corresponding diagnostic efficiencies.

The foregoing descriptions of various aspects of the present invention are presented for purposes of illustration and description. They are not intended to be exhaustive nor to limit the invention to the precise forms disclosed and, obviously, many modifications and variations are possible in light of the above teaching. For example, each of the visual indicators 210 and 214 may be multistage indicators. Such modifications and variations that may be apparent to a person skilled in the art are intended to be included within the scope of the invention as defined by the accompanying claims.

Having thus described the invention what is claimed as new and desired to be secured by Letters Patent is as follows:

1. A visual indicator system, comprising:
a fuel injector pulse width signal generator in communication with an engine fuel injector by means of a circuit wire; and,
a visual indicator in circuit communication with the circuit wire and configured to light up in a first stage to indicate a good electrical connection of the fuel injector to the fuel injector pulse width signal generator to the engine fuel injector through the circuit wire when the fuel injector signal generator, the engine fuel injector and the circuit wire are energized by a vehicle ignition system.

2. The system of claim 1, wherein the visual indicator is further configured to light up a second stage to indicate a good pulse width signal generator operation when an automobile engine is running through operation of the fuel injector signal generator, the engine fuel injector and the circuit wire.

3. The system of claim 2, wherein the pulse width signal generator is configured to generate a modified pulse width signal that is approximately 25% greater than a pulse width signal generated by an engine control unit.

4. A method, comprising the steps of:
monitoring an engine fuel injector pulse width circuit wire for a fault condition; and,
lighting up a first stage visual indicator in circuit communication with the circuit wire to indicate a good electrical connection of a fuel injector pulse width signal generator to a fuel injector through the circuit wire when the fuel injector signal generator, the engine fuel injector and the circuit wire are energized by a vehicle ignition system.

5. The method of claim 4, further comprising a step of a second stage visual light indicator lighting up when an automobile engine is running properly through nonfaulty operation of the fuel injector signal generator, the engine fuel injector and the circuit wire.

6. The method of claim 5, further comprising the steps of:
modifying pulse width signal inputs from an engine control unit to generate a modified pulse width signal output to the fuel injector;
optimizing the pulse width signal for a gasoline blend; and,
optimizing the modified pulse width signal for an E85 fuel blend.

7. The method of claim 6, wherein the step of modifying the pulse width signal comprises widening the pulse width signal by a widening factor.

8. The method of claim 7, wherein the step of modifying the pulse width signal comprises widening the pulse width signal by about 25%.
